(19) United States
(12) Patent Application Publication
(10) Pub. No.: US 2026/0363927 A1
(43) Pub. Date: Nov. 19, 2026

(54) Assisted Standing and Seating Support System and Methods

(71) Applicant: Tanya Brynne Presta, Highlands Ranch, CO (US)

(72) Inventor: Tanya Brynne Presta, Highlands Ranch, CO (US)

(21) Appl. No.: 19/545,029

(22) Filed: Feb. 20, 2026

Related U.S. Application Data
(60) Provisional application No. 63/760,127, filed on Feb. 19, 2025.

(51) Int. Cl. A61G 5/14

(52) U.S. Cl. CPC A61G 5/14

(57) ABSTRACT

A portable assisted standing and seating support system and associated methods are disclosed. The system includes a self-supporting frame, a user-engageable interface movable along a guided path, an energy-storage mechanism, a control assembly configured to regulate movement. The system provides controlled assistance and resistance during transitions between seated and standing positions, improving user safety and mobility without permanent installation.

### CROSS-REFERENCE TO RELATED APPLICATIONS

This application claims the benefit of U.S. Provisional Patent Application No. 63/760,127, filed Feb. 19, 2025, the entirety of which is incorporated herein by reference.

### FIELD OF THE INVENTION

The present disclosure relates generally to mobility assistance devices and, more particularly, to portable systems and methods configured to assist a user during controlled transitions between seated and standing positions.

### BACKGROUND OF THE INVENTION

Many individuals experience difficulty transitioning between seated and standing positions due to limited strength, reduced mobility, injury, post-surgical recovery, age-related decline, neurological conditions, or other physical limitations. Conventional assistance devices often require permanent installation, external assistance, powered actuators, or exertion levels that exceed a user's capabilities. Other existing devices may provide only unidirectional assistance, insufficient control during descent, or limited adaptability for users having different physical characteristics or support requirements.

Accordingly, there exists a need for a portable, self-supporting assistance system capable of providing controlled assistance during both standing and sitting motions while permitting user-adjustable operation, controlled movement, and stable support without permanent installation or external power.

### SUMMARY OF THE INVENTION

The present disclosure provides an assisted standing and seating support system configured to facilitate controlled transitions between seated and standing positions.

In one embodiment, the system includes a housing, a user-engageable handle assembly movable along a guided path relative to the housing, an energy-storage mechanism operatively coupled to the handle assembly, and an assistance and control assembly configured to selectively permit, resist, or restrict movement of the handle assembly.

In certain embodiments, the system provides controlled assistance during a standing motion and controlled resistance during a sitting motion. The assistance and control assembly may include one or more locking mechanisms, dampeners, adjustment mechanisms, or combinations thereof that permit the system to be configured for users having different strengths, preferences, or operating conditions.

In various embodiments, the energy-storage mechanism may comprise one or more compression springs, gas springs, elastic members, constant-force springs, torsion springs, resilient members, or other mechanisms capable of storing and releasing mechanical energy.

The assistance and control assembly may include one or more dampeners configured to moderate movement of the handle assembly during compression, extension, or both, thereby reducing abrupt motion and improving user control.

In another aspect, methods are disclosed for assisting a user during transitions between seated and standing positions using a portable support system, including selectively releasing a locking mechanism, moving a handle assembly along a guided path, storing and releasing mechanical energy through an energy-storage mechanism, regulating movement through one or more dampeners, and selectively securing the system after completion of a transition.

The embodiments described herein are illustrative rather than limiting, and the invention is not restricted to any particular geometry, dimensions, materials, mechanical implementation, or combination of components except as expressly recited in the claims.

### BRIEF DESCRIPTION OF THE DRAWINGS

The accompanying drawings illustrate exemplary embodiments of the disclosed assisted standing and seating support system and are provided for purposes of illustration rather than limitation.

FIG. 1 is a perspective view of an exemplary assisted standing and seating support system according to one embodiment of the present disclosure.

FIG. 2 is a front elevation view of the assisted standing and seating support system of FIG. 1.

FIG. 3 is a side elevation view of the assisted standing and seating support system of FIG. 1.

FIG. 4 is a rear elevation view of the assisted standing and seating support system of FIG. 1.

FIG. 5 is an exploded view of an exemplary assistance and control assembly configured for use with the assisted standing and seating support system.

### DETAILED DESCRIPTION OF THE INVENTION

The following description sets forth exemplary embodiments of an assisted standing and seating support system. It will be understood that the embodiments described herein are illustrative rather than limiting and that various modifications, substitutions, additions, omissions, and equivalent structures may be employed without departing from the scope of the invention.

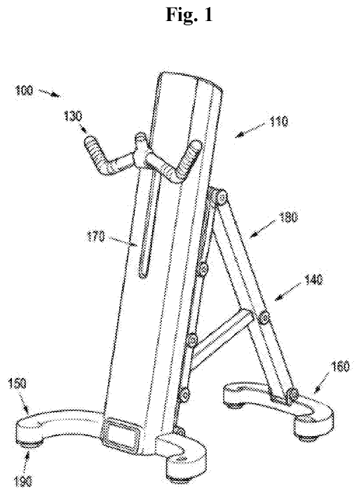

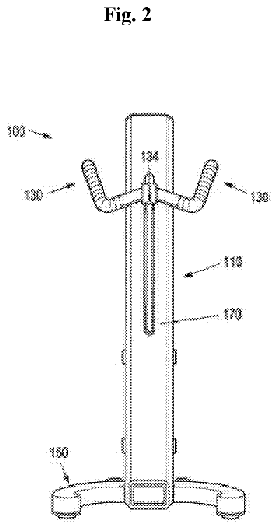

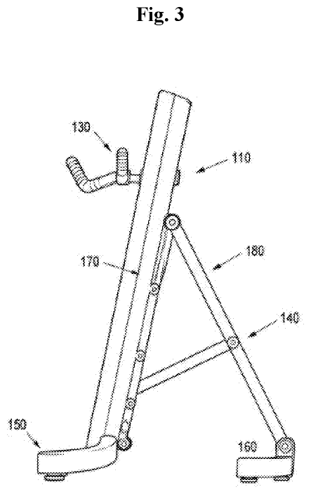

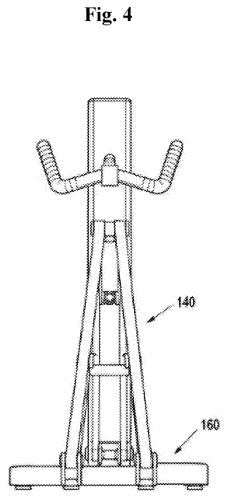

Referring generally to FIGS. 1-5, an assisted standing and seating support system 100 includes a housing 110, a handle assembly 130, a rear support leg assembly 140, a front stabilizer base 150, a rear stabilizer base 160, a guide track 170, a pivot mechanism 180, one or more foot pads 190, and an assistance and control assembly 300.

The housing 110 forms the primary structural member of the system and provides support for the movable components while defining a guided path along which the handle assembly 130 is configured to travel. The housing may be fabricated from metal, composite materials, engineered polymers, or combinations thereof, and may include one or more internal cavities configured to receive portions of the assistance and control assembly 300.

The guide track 170 extends along at least a portion of the housing 110 and guides movement of the handle assembly 130 during operation. Although illustrated as a generally linear guide path, the guide track 170 may alternatively comprise curved, segmented, telescoping, rolling, sliding, or other guided movement mechanisms without departing from the scope of the invention.

The handle assembly 130 provides a user-engageable interface through which force is applied during standing and sitting transitions. In the illustrated embodiment, the handle assembly includes a central handle connector 134 configured to couple the handle assembly 130 to the movable assistance and control assembly 300. The handle assembly may be configured to be grasped by a user 4 and may include ergonomic contours, resilient grip materials, textured surfaces, adjustable grip spacing, or other user-interface features.

The rear support leg assembly 140 is pivotably coupled to the housing 110 through the pivot mechanism 180. During operation, the rear support leg assembly cooperates with the front stabilizer base 150 and rear stabilizer base 160 to provide a stable support structure capable of resisting tipping, lateral movement, or excessive frame deflection while the system is subjected to user loading.

The front stabilizer base 150 and rear stabilizer base 160 may each include one or more foot pads 190 configured to engage a supporting surface. The foot pads 190 may comprise elastomeric materials, friction-enhancing materials, adjustable leveling feet, or other structures configured to improve stability while minimizing movement of the system during use.

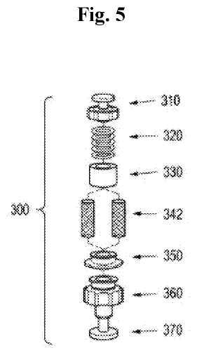

Referring particularly to FIG. 5, the assistance and control assembly 300 generally includes an upper retainer 310, an energy-storage mechanism 320, a carriage 330, one or more dampeners 342, a lower retainer 350, a locking mechanism 360, and a lower actuator 370.

The upper retainer 310 and lower retainer 350 cooperate to support and position the remaining components of the assistance and control assembly 300 within the housing 110. The illustrated arrangement is exemplary only, and numerous alternative support structures may be employed while remaining within the scope of the present disclosure.

The energy-storage mechanism 320 is configured to store mechanical energy during one portion of the user's movement and release stored mechanical energy during another portion of the user's movement. In certain embodiments, the energy-storage mechanism 320 comprises one or more compression springs. However, the energy-storage mechanism may alternatively comprise gas springs, torsion springs, constant-force springs, elastomeric members, resilient materials, pneumatic elements, hydraulic accumulators, magnetic mechanisms, or other structures capable of storing and releasing mechanical energy.

The carriage 330 is operatively coupled to the handle assembly 130 and is configured to translate along the guide track 170 during operation of the system. As the carriage moves relative to the housing 110, the carriage cooperates with the energy-storage mechanism 320 to provide controlled assistance and resistance during standing and sitting transitions.

One or more dampeners 342 are operatively associated with the carriage 330 and are configured to regulate movement of the carriage during operation. In the illustrated embodiment, the assistance and control assembly includes a pair of dampeners 342. The dampeners may resist movement during compression, extension, or both, thereby reducing abrupt acceleration or deceleration of the handle assembly 130. In certain embodiments, the dampeners provide bidirectional resistance to improve user comfort and increase operational stability. Other embodiments may employ friction dampening, hydraulic dampening, pneumatic dampening, magnetic dampening, viscous dampening, or combinations thereof.

The locking mechanism 360 selectively permits or restricts movement of the carriage 330 relative to the housing 110. In various embodiments, the locking mechanism may include one or more mechanical latches, pawls, detents, friction locks, cam mechanisms, electromagnetic locks, or other selectively engageable retaining mechanisms.

The lower actuator 370 cooperates with the locking mechanism 360 to selectively engage or disengage movement of the carriage 330. Although illustrated as a manually actuated component, the lower actuator may alternatively comprise a cable-operated actuator, lever, push button, pedal, electronic actuator, remote actuator, or other suitable release mechanism.

The assistance and control assembly 300 illustrated in FIG. 5 is intended as one exemplary embodiment. Various components may be added, removed, repositioned, substituted, or combined while remaining within the scope of the present disclosure. Likewise, the relative arrangement of the illustrated components should not be construed as limiting unless expressly recited in the claims.

During operation, the assisted standing and seating support system 100 is positioned adjacent a chair, bench, bed, wheelchair, toilet, or other seating surface. The user grasps the handle assembly 130 and, where applicable, disengages the locking mechanism 360 through operation of the lower actuator 370 or another suitable release mechanism. Once released, the carriage 330 is permitted to translate along the guide track 170 relative to the housing 110.

As the user applies force to the handle assembly 130 while transitioning toward a standing position, the energy-storage mechanism 320 provides assistive force that reduces the amount of effort required by the user. Simultaneously, one or more dampeners 342 moderate movement of the carriage 330, thereby reducing abrupt acceleration and providing a smooth, controlled transition.

Conversely, when the user transitions from a standing position toward a seated position, the energy-storage mechanism 320 is progressively recharged while the dampeners 342 provide controlled resistance that assists in regulating the user's descent. The cooperation between the energy-storage mechanism 320, carriage 330, and dampeners 342 enables the system to provide controlled assistance during both standing and sitting motions.

Upon completion of a transition, the locking mechanism 360 may selectively secure the carriage 330 relative to the housing 110 until the user initiates another transition. In some embodiments, the locking mechanism automatically engages upon completion of travel. In other embodiments, engagement may be performed manually or electronically.

Although the illustrated embodiment depicts a generally upright housing 110 supported by a rear support leg assembly 140, numerous alternative frame geometries may be employed. Likewise, the stabilizer bases 150 and 160 may assume alternative shapes, sizes, orientations, or support configurations while providing the desired stability characteristics.

Similarly, although the illustrated handle assembly 130 includes a generally transverse user-engageable configuration coupled through the handle connector 134, numerous ergonomic configurations may be employed depending upon the intended application, user preference, or manufacturing considerations. The handle assembly may further include adjustable grip spacing, interchangeable grip elements, resilient coverings, textured surfaces, or other ergonomic features.

The energy-storage mechanism 320, dampeners 342, locking mechanism 360, carriage 330, guide track 170, and associated structural components may each be manufactured from metals, engineered polymers, composite materials, ceramics, elastomeric materials, or combinations thereof. Manufacturing processes may include machining, casting, molding, additive manufacturing, extrusion, stamping, forging, fabrication, or other suitable techniques.

The relative dimensions, proportions, orientations, materials, and component arrangements illustrated in the accompanying drawings are intended solely as exemplary embodiments. Unless expressly recited in the claims, no particular dimension, angle, spacing, ratio, material selection, manufacturing process, or component configuration should be interpreted as limiting the scope of the invention.

Various features described in connection with one embodiment may be combined with features described in other embodiments. Likewise, individual components may be omitted, duplicated, substituted, repositioned, or integrated with other components while remaining within the scope of the present disclosure.

The embodiments described herein are intended to illustrate the principles of the invention rather than define its limits. Numerous modifications, substitutions, additions, deletions, rearrangements, and equivalent structures will become apparent to those of ordinary skill in the art upon review of this disclosure. Accordingly, the invention is intended to encompass all such modifications and equivalents falling within the scope of the appended claims.

1. An assisted standing and seating support system comprising:
a self-supporting frame;
a user-engageable interface movably coupled to the frame and configured to travel along a guided path relative to the frame;
an energy-storage mechanism operatively coupled to the user-engageable interface;
and a control assembly configured to selectively permit, resist, or restrict movement of the user-engageable interface, wherein the system is configured to assist a user during transitions between seated and standing positions.

2. An apparatus for assisting user mobility, comprising:
a portable support structure configured to rest on a surface;
at least one handle coupled to the support structure for guided movement;
a force-providing mechanism operatively connected to the handle; and a locking mechanism configured to selectively immobilize the handle, wherein movement of the handle provides controlled assistance or resistance during both standing and seating motions.

3. A method of assisting a user in transitioning between seated and standing positions, comprising: positioning a portable support system relative to a user;
engaging a user-engageable interface of the system;
unlocking a control assembly to permit guided movement of the interface;
applying controlled assistance or resistance via an energy-storage mechanism during movement of the interface; and
locking the interface upon completion of the transition.
